(19) United States
(12) Patent Application Publication
(10) Pub. No.: US 2003/0041111 A1
(43) Pub. Date: Feb. 27, 2003

(54) System for emailing images with audio as a separate file

(76) Inventors: Beth M.P. Delaney, Loveland, CA (US); Thomas W. Yip, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/939,958

(22) Filed: Aug. 27, 2001

(51) Int. Cl. G06F 15/16

(52) U.S. Cl. 709/206; 709/247

(57) ABSTRACT

A system for extracting an audio file embedded in an image file and attaching the extracted audio file to an image file in an electronic mail message is disclosed. The system includes a software code segment for extracting an embedded audio file from an image file, a memory for storing the extracted audio file and a software code segment for associating the extracted audio file with the image file in an electronic message.

### BACKGROUND OF THE INVENTION

1. Field of the Invention

The invention relates generally to electronic mailing of images and audio, and, more particularly, to a system for emailing images and audio as separate files in the same email.

2. Related Art

Digital photography is becoming more and more popular due to the availability of affordable digital cameras. As these digital cameras continue to be developed, new features continually become available. Due to advances in memory design, the storage capacity of digital cameras continues to increase, thus continually making available new and advanced features. For example, one new feature in digital still cameras is the ability to record a brief audio annotation for a still image. The audio annotation can be embedded in the image file, thus providing a narration for the image.

One of the primary benefits of digital still cameras over conventional film cameras is the ease with which the images can be transferred and manipulated. For example, with virtually all digital still cameras the image files can be easily transferred to a personal computer. Once the image file is loaded onto the computer, the image can be electronically manipulated, printed or electronically transferred to other computers, via, for example, the Internet.

One typical manipulation that is commonly performed is the electronic mailing (or emailing) of images. For example, images can be emailed to extended family members so that they can immediately share the images. Unfortunately, when electronic images that include an embedded audio file are electronically transferred, there is typically no efficient way for the recipient of the image to know that there is an embedded audio file. This results in situations in which the recipient ignores the audio file because they do not know that it is there. Further, even if the recipient is aware of the presence of the audio file, additional software that can extract and play the audio file is typically required.

Therefore, it would be desirable for an efficient and convenient way to notify the recipient of an electronically transferred image file that the image includes an embedded audio file, and a way to allow the recipient to conveniently play the audio file.

### SUMMARY

A system for extracting an audio file embedded in an image file and attaching the extracted audio file to an image file in an electronic mail message is disclosed. The system includes a software code segment for extracting an embedded audio file from an image file, a memory for storing the extracted audio file and a software code segment for associating the extracted audio file with the image file in an email message.

### BRIEF DESCRIPTION OF THE DRAWINGS

The invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar processing environment in which the invention resides.

FIG. 2 is a block diagram illustrating an exemplar graphical user interface (GUI) presented to a user of the computer by the camera software of FIG. 1.

FIG. 3 is a block diagram illustrating an exemplar GUI presented to a user of the computer by the email portal of FIG. 1.

FIG. 4 is a block diagram illustrating an exemplar GUI presented to a user of the computer by the email program of FIG. 1.

FIG. 5 is an exemplar GUI presented to a recipient of the email message of FIG. 4.

FIG. 6 is a flow chart illustrating an example of the operation of one embodiment of the invention.

### DETAILED DESCRIPTION OF THE PREFERRED EMBODIMENT

The system for extracting and attaching an embedded audio file to an image file can be implemented in software (e.g., firmware), hardware, or a combination thereof In one embodiment, the system for extracting and attaching an embedded audio file to an image file is implemented using a personal computer (PC). However, regardless of the manner of implementation, the software portion of the invention can be executed by a special or general purpose computer, such as a personal computer (PC; IBM-compatible, Apple-compatible, or otherwise), workstation, minicomputer, or mainframe computer. Furthermore, the invention may be implemented in other processing or computing devices, such as, for example but not limited to, a palmtop computer, a personal data assistant (PDA), etc.

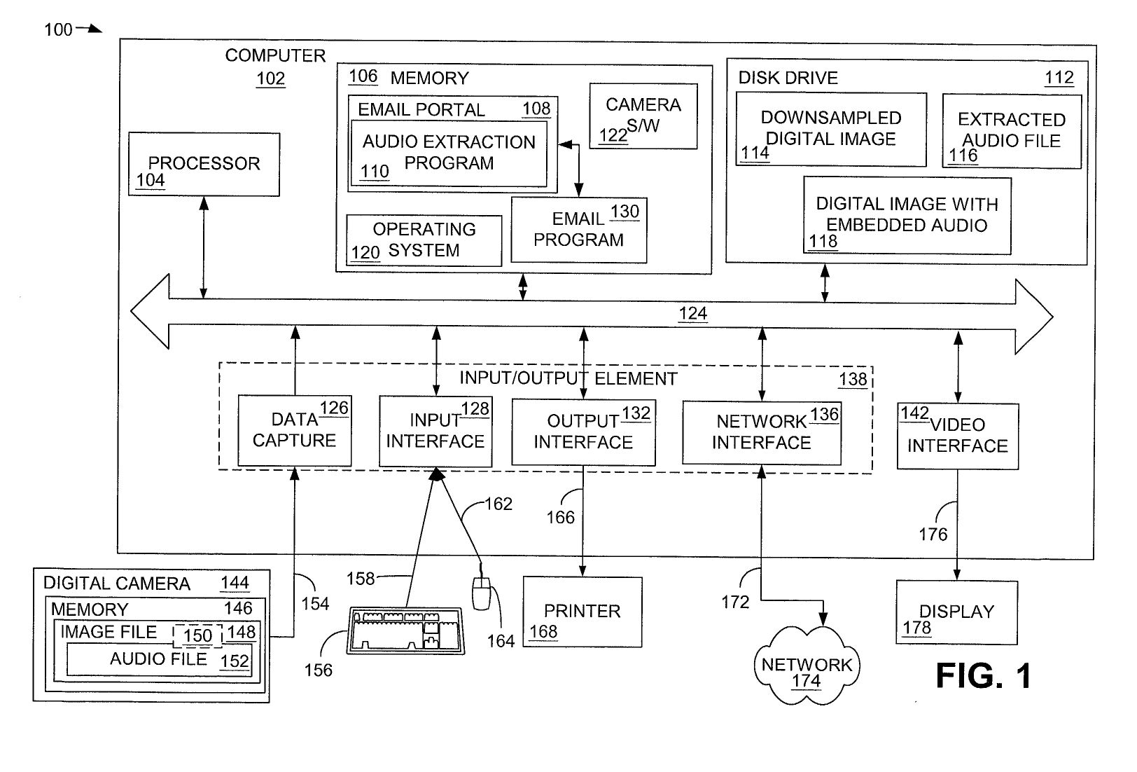

FIG. 1 is a schematic view illustrating an exemplar processing environment 100 in which the invention resides. As mentioned above, in one embodiment, the system for extracting and attaching an embedded audio file to an image file is implemented primarily in software using a general purpose computer, such as the computer 102 shown in FIG. 1

The computer 102 includes a memory, which includes software in the form of an audio extraction code segment 110. The audio extraction code segment 110 and other software and hardware elements (to be discussed with respect to FIG. 1) work in unison to implement the functionality of the invention. Generally, in terms of hardware architecture, as shown in FIG. 1, the computer 102 includes a processor 104, a memory 106, a disk drive 112, a video interface 142 and an input/output element 138 that are connected together and can communicate with each other via a local interface 124. The local interface 124 can be, for example but not limited to, one or more buses or other wired or wireless connections, as is known to those having ordinary skill in the art. The local interface 124 may have additional elements, which are omitted for simplicity, such as buffers (caches), drivers, and controllers, to enable communications. Further, the local interface 124 includes address, control, and data connections to enable appropriate communications among the aforementioned components. The input/output element 138 includes a data capture element 126, an input interface 128, an output interface 132 and a network interface 136 each in communication with the local interface 124. The disk drive can be any storage element or memory device, and as used herein, refers to a computer hard disk drive.

The processor 104 is a hardware device for executing software that can be stored in memory 106. The processor 104 can be any custom made or commercially available processor, a central processing unit (CPU) or an auxiliary processor among several processors associated with the computer 102, and a microchip-based microprocessor or a macroprocessor. Examples of suitable commercially available microprocessors are as follows: a PA-RISC series microprocessor from Hewlett-Packard Company, an 80x86 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 106 can include any one or a combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 106 may incorporate electronic, magnetic, optical, and/or other types of storage media. Note that the memory 106 can have a distributed architecture, where various components are situated remote from one another, but can be accessed by the processor 104. The input interface 128 can receive commands from, for example, keyboard 156 via connection 158 and from mouse 164 via connection 162 and transfer those commands over the local interface 124 to the processor 104 and the memory 106.

In accordance with an embodiment of the invention, a digital camera 144 is coupled to the computer 102 via connection 154 and the data capture element 126. The data capture element 126 is part of the input/output element 138 and receives inputs from the digital camera 144. The digital camera 144 includes a memory 146. The memory 146 can be any type of memory employed in digital cameras, and can be, for example, but not limited to, a fixed or removable memory media. In operation, the digital camera 144 stores images in the form of an image file 148. The image file may include an embedded audio file 152. When digital images (image file 148) are captured and stored in a digital camera 144, it is desirable to transfer the image file 148 from the memory 146 to, for example, a computer 102. When the image file 148 is transferred to the computer 102, the image file 148 can be further manipulated, as will be described below.

The video interface 142 supplies a video output signal via connection 176 to the display 178. The display 178 can be a conventional CRT based display device, or can be any other display device, such as a liquid crystal display (LCD) or other type of display.

The output interface 132 sends printer commands via connection 166 to the printer 168. The network interface 136, which can be, for example, a network interface card located in the computer 102, a dial-up modulator/demodulator (modem), a digital subscriber line (DSL) transceiver or cable modem, or any other communication device capable of connecting the computer 102 to an external network 174.

The software in memory 106 may include one or more separate programs, each of which comprise one or more code segments, which are an ordered listing of executable instructions for implementing logical functions. In the example of FIG. 1, the software in the memory 106 includes an email portal 108, which includes audio extraction code segment 110. The memory 106 also includes an email program 130 and a suitable operating system (O/S) 120. Further, the memory 106 includes a digital camera software component 122 that allows a user of the computer to upload, print, email and view the image file 148.

The email portal 108 is a software component that compresses an image file 148 into a downsampled digital image 114 and allows a user to combine the image files 148 into an email message for electronic transfer. Downsampling refers to compressing a file so that it occupies less memory space than before being compressed. The email portal 108 includes the audio extraction code segment 110, which is a code segment that is used by the email portal 108 to enable the extraction of an embedded audio file 152 from an image file 148. After extraction by the audio extraction code segment 110, the email portal 108 creates an extracted audio file 116. The extracted audio file, can be, for example, a Microsoft audio WAV (.wav) file and is stored in the disk drive 112 until emailed. The extracted audio file 116 may also be compressed to reduce the amount of storage space required in the disk drive 112.

With respect to the operating system 120, a non-exhaustive list of examples of suitable commercially available operating systems 120 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 120 essentially controls the execution of other computer programs, such as the audio extraction program 110, and provides scheduling, input-output control, file and data management, memory management, and communication control and related services. The processor 104 and operating system 120 define a computer platform, for which application programs, such as the email program 130 and the audio extraction code segment 110, in higher level programming languages are written. The audio extraction code segment 110 includes the software that allows the computer 102 to detect and extract audio embedded in an image file.

If the computer 102 is a PC, the software in the memory 106 further includes a basic input output system (BIOS) (omitted for simplicity). The BIOS is a set of essential software routines that test hardware at startup, start the O/S 120, and support the transfer of data among the hardware devices. The BIOS is stored in ROM so that it can be executed when the computer 102 is activated.

When the computer 102 is in operation, the processor 104 is configured to execute software stored within the memory 106, to communicate data to and from the memory 104 and to generally control operations of the computer 102 pursuant to the software. The email portal 108, audio extraction code segment 110, camera software 122, email program 130 and the O/S 120, in whole or in part, but typically the latter, are read by the processor 104, perhaps buffered within the processor 104, and then executed.

When the system for extracting and attaching an embedded audio file to an image file is implemented primarily in software, as is shown in FIG. 1, it should be noted that the email portal 108, audio extraction code segment 110, camera software 122 and the email program 130 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The email portal 108, audio extraction code segment 110, camera software 122 and the email program 130 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the system for extracting and attaching an embedded audio file to an image file can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One of the more typical manipulations performed on the image file 148 is the electronic transfer of the image file 148 to another computer. For example, it is common to append the image file 148 to an electronic mail (email) message and send the image file 148 to friends or family. The emailed image file 148 can then be viewed by others.

However, when the image file 148 includes an embedded audio file 152, it is not typically apparent to a recipient of the email message that the image file 148 includes an embedded audio file 152. In accordance with an embodiment of the invention, when the image file 148 is transferred to the computer 102 and stored in the disk drive 112 as a digital image with an embedded audio file 118, the email portal 108 invokes the audio extraction code segment 110 to detect and extract an audio file 152 embedded in the image file 148. To illustrate an example, assume that the image file 148 is a joint picture experts group (JPEG, .jpg) file. The .jpg format is structured in such a way that arbitrary information, such as audio data (audio file 152), can be embedded in the image file 148 using what is referred to as a “marker.” The email portal 108 invokes the audio extraction code segment 110 to search for an audio marker 150 located in the image file 148, which, in this example, is a .jpg file. If an audio marker 150 is discovered, the audio extraction code segment 110 then copies the audio data (audio file 152), bit for bit, into a separate file that is stored in the disk drive 112 as the extracted audio file 116. In this manner, the audio extraction code segment 110 extracts the audio file 152 from the image file 148. In this example, the audio data (audio file 152) embedded in the .jpg file (image file 148) is a Microsoft audio WAV file, so when extracted, it is playable using, for example, a Windows Media Player. Once the audio file 152 is extracted from the image file 148, the email portal 108 compresses the image file 148 into a downsampled digital image 114.

The downsampled digital image 114 and the extracted audio file 116 are then available in the disk drive 112 and can be appended to an email message by the email portal 108.

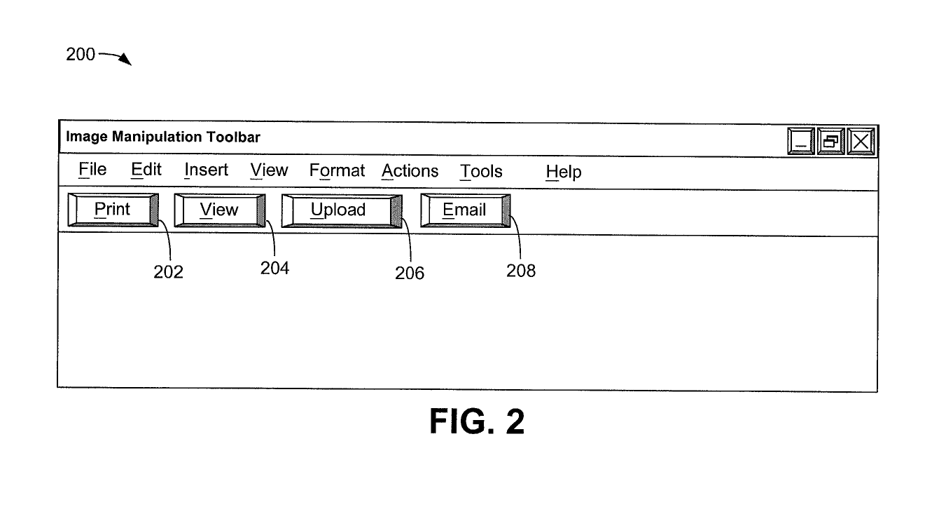

FIG. 2 is a block diagram illustrating an exemplar graphical user interface (GUI) 200 presented to a user of the computer 102 by the camera software 122 of FIG. 1. The GUI 200 is presented to a user of the computer 102 when the user of the computer 102 wishes to transfer an image file 148 from the digital camera 144 to the computer 102 and electronically manipulate the image file 148 using the computer 102. When the camera software 122 is activated, the GUI 200 presents the user of the computer 102 with a series of choices. For example, by pressing button 202 a selected image can be printed. Similarly, by pressing button 204, a selected image can be viewed, by pressing button 206 a selected image can be uploaded, and by pressing button 208 a selected image can be emailed. When a user of the computer 102 wishes to email an image, the activation of button 208 invokes the email portal 108 of FIG. 1.

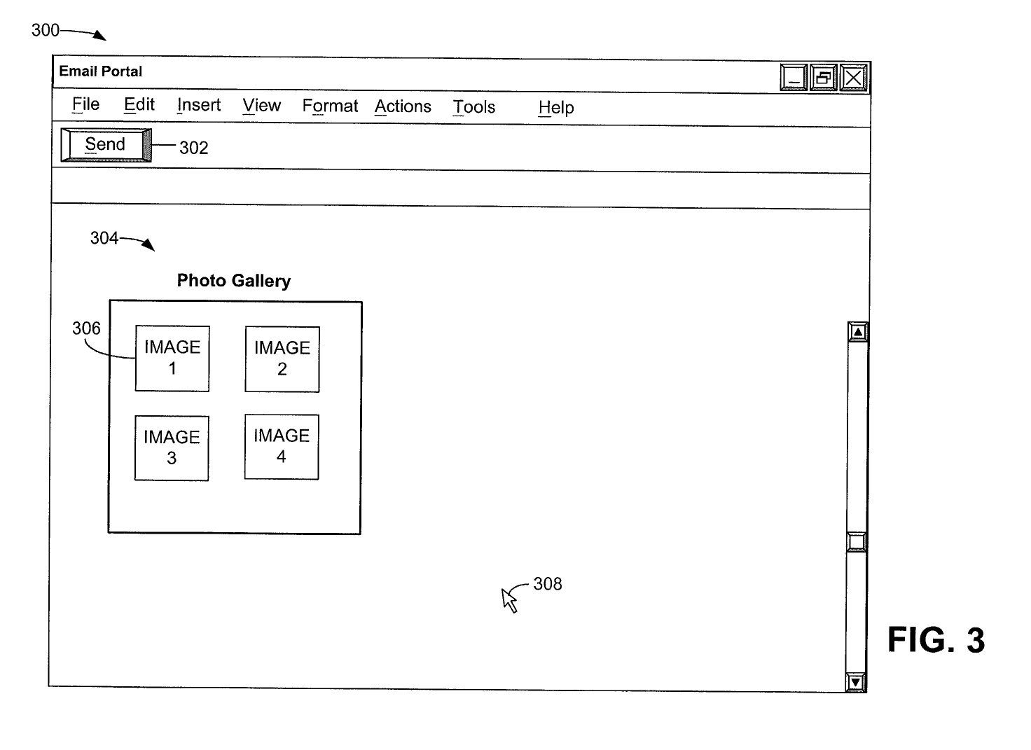

FIG. 3 is a block diagram illustrating an exemplar GUI 300 presented to a user of the computer 102 by the email portal 108 of FIG. 1. The GUI 300 allows a user of the computer 102 to place one or more images, an exemplar one of which is illustrated using reference numeral 306, into a photo gallery 304. The photo gallery 304 indicates the images that will be emailed by the computer 102. When the user decides which images to include in the photo gallery 304, the user can use the pointer tool 308 to press the button 302 in order to email these images. When the user of the computer 102 indicates to the email portal 108 (FIG. 1) that the images 306 are ready for emailing, the email portal 108 invokes the email program 130 (FIG. 1).

In accordance with an embodiment of the invention, when an image (such as image 306 of FIG. 3) is placed in the photo gallery 304 and the user activates the button 302 to invoke the email program 130, the email portal 108 invokes the audio extraction code segment 110 to analyze each image 306 to determine whether an audio file 152 is embedded within the image file 148. In this example, the image file 148 (FIG. 1) is represented by the image 306. If the audio extraction code segment 110 determines that the image does not include an embedded audio file, then the email portal 108 compresses, or downsamples, the image and places the downsampled digital image 114 (FIG. 1) representing the image 306 into a storage location in the disk drive 112.

If the audio extraction code segment 110 discovers an audio marker 150 in the image file 148 indicating that the image file 148 includes an audio file 152, the audio extraction code segment 110 (FIG. 1) extracts the audio file 152 from the image file 148 (FIG. 1) by copying the data, bit for bit, into a separate file (extracted audio file 116). The extracted audio file 116 is playable, or executed, by using, for example, a Windows Media Player. If the audio extraction code segment 110 detects and extracts an audio file 152, the extracted audio file 116 is placed into a storage location in the disk drive 112 of FIG. 1.

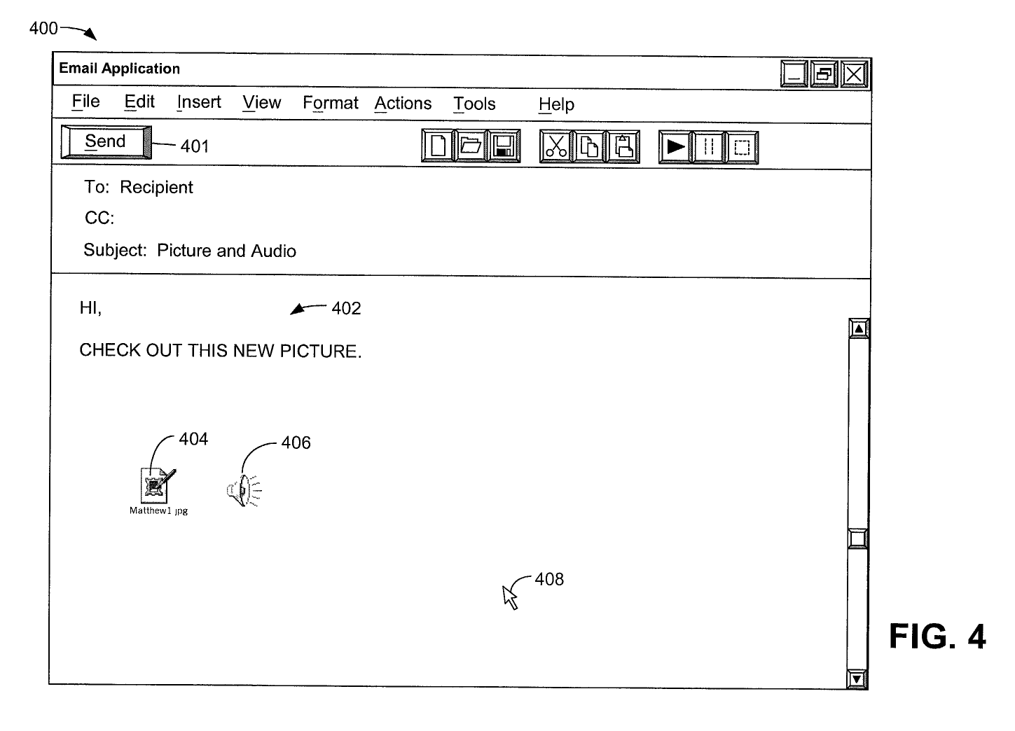

FIG. 4 is a block diagram illustrating an exemplar GUI 400 presented to a user of the computer 102 by the email program 130 of FIG. 1. The GUI 400 illustrates one possible implementation of a representative email message and includes a send button 401, and a message field 402. The message field 402 is the location in the email message in which a user types a message to a recipient of the email message. If the email portal 108 determines that an image file 148 includes an embedded audio file 152, then the email portal 108, by invoking the audio extraction code segment 110, takes the extracted audio file 116 and creates a separate audio file. For example, the extracted audio file could be saved as a wave (.wav) file. In such an instance, the downsampled digital image 114 and the extracted audio file 116 are separately placed in the email message of FIG. 4, as illustrated using the icons 404 and 406, respectively. The icon 404 represents the down sampled digital image 114 of FIG. 1 while the icon 406 represents the extracted audio file 116 of FIG. 1.

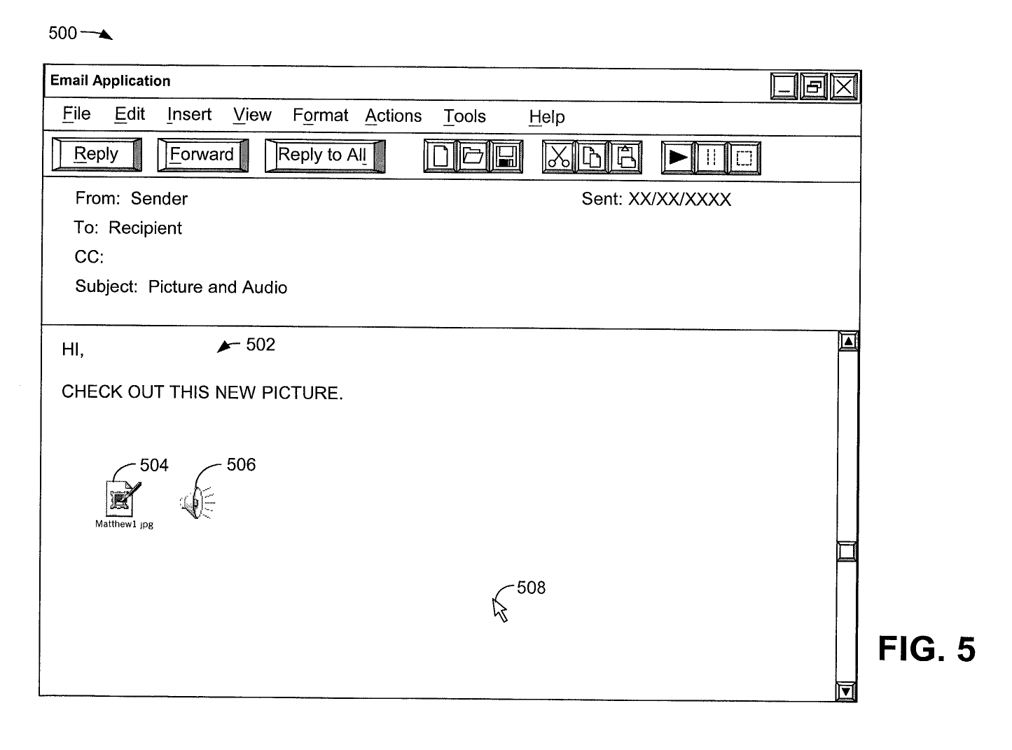

FIG. 5 is an exemplar GUI 500 presented to a recipient of the email message of FIG. 4. The GUI 500 includes a message field 502 in which the recipient of the email receives the message sent by the sender. Furthermore, the recipient of the email message also receives icons 504 and 506, which correspond to the icons 404 and 406, respectively, of FIG. 4. When the recipient receives the email message, the recipient can use the pointer 508 to click on the icon 504 in order to view the image, and can click on the icon 506 in order to listen the embedded audio file. The image file, represented by icon 504, and the extracted audio file, represented by icon 506, are separately executable. It should be noted that the examples shown are for illustrative purposes only and should not be construed as the only embodiment of the invention. Other email programs and graphical user interfaces can be used to implement the concepts of the invention.

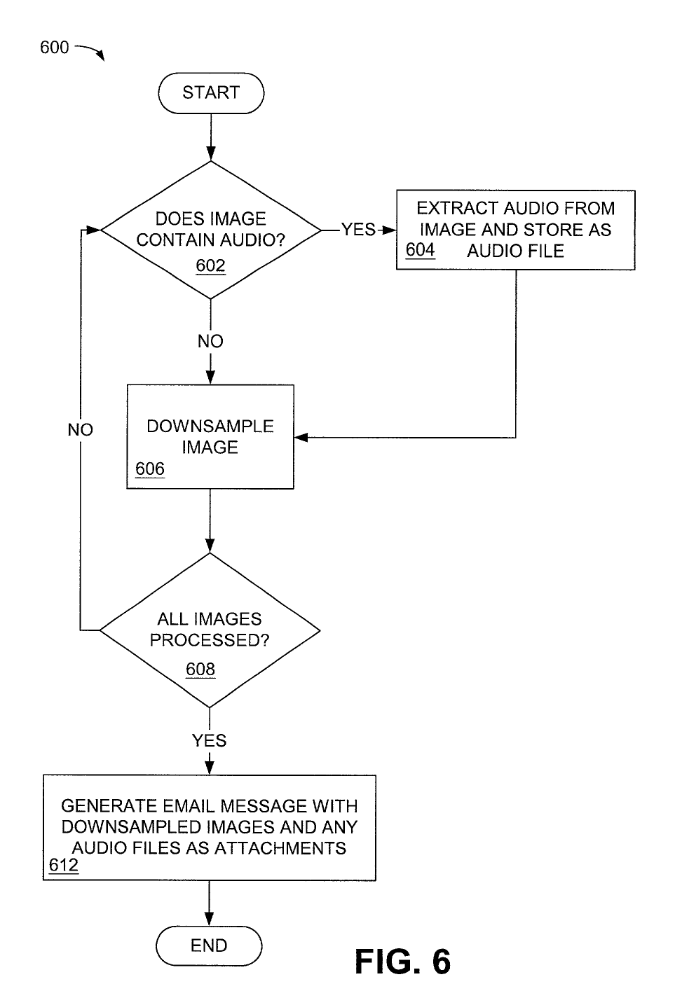

FIG. 6 is a flow chart 600 illustrating an example of the operation of one embodiment of the invention. The flow chart of FIG. 6 shows the architecture, functionality, and operation of a possible implementation of the email portal 108 and the audio extraction code segment 110 of FIG. 1. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved, as will be further clarified below.

In block 602 the email portal 108 and the audio extraction code segment 110 determine whether an image file (148 of FIG. 1) contains an embedded audio file (152 of FIG. 1). If the image file 148 does not contain an embedded audio file 152, then, in block 606 the image file 148 is compressed, or downsampled, and stored in the disk drive 112 as a downsampled digital image 114.

If, in block 602, the email portal 108 and the audio extraction code segment 110 determine that the image file 148 contains an embedded audio file 152, then, in block 604, the audio extraction code segment 110 extracts the embedded audio file 152 from the image file 148 and stores the extracted audio file 116 in the disk drive 112.

Then, in block 606, the image is compressed into a downsampled digital image 114 and stored in the disk drive 112. Then, in block 608, the email portal 108 determines whether all images have been processed. If not, then the process returns to block 602. If, in block 608, the email portal 108 determines that all the images have been processed, then, in block 612, the email portal 108 invokes the email program 130 to generate an email message having the downsampled image 114 and the extracted audio file 116 embedded as attachments.

It will be apparent to those skilled in the art that many modifications and variations may be made to the preferred embodiments of the present invention, as set forth above, without departing substantially from the principles of the present invention. For example, the system for extracting and attaching an embedded audio file to an image file can be used in any digital camera/computer environment to extract an embedded audio file from an image file. All such modifications and variations are intended to be included herein within the scope of the present invention, as defined in the claims that follow.

What is claimed is:

1. A system for extracting an embedded audio file from an image file, comprising:
a software code segment for extracting an audio file embedded in an image file;
a memory for storing the extracted audio file; and
a software code segment for associating the extracted audio file with the image file.

2. The system of claim 1, wherein the extracted audio file and the image file are attached to an email message.

3. The system of claim 2, wherein the extracted audio file and the image file are represented in the email message by separate icons.

4. The system of claim 1, wherein the image file is compressed.

5. The system of claim 1, wherein the software code segment for extracting the embedded audio file analyzes the image file for a marker representing the embedded audio file.

6. The system of claim 1, wherein the extracted audio file and the image file are separately executable.

7. A method for allowing a recipient of an electronic mail message to play an audio file embedded in an image file, comprising:
providing an image file having an embedded audio file;
extracting the embedded audio file;
storing the extracted audio file; and
associating the extracted audio file with the image file.

8. The method of claim 7, further comprising attaching the extracted audio file and the image file to an email message.

9. The method of claim 8, further comprising representing the extracted audio file and the image file using separate icons.

10. The method of claim 7, further comprising compressing the image file

11. The method of claim 7, further comprising extracting the embedded audio file by analyzing the image file for a marker representing the embedded audio file.

12. The method of claim 7, wherein the extracted audio file and the image file are separately executable.

13. A system for allowing a recipient of an electronic mail message to play an audio file embedded in an image file, comprising:
means for providing an image file having an embedded audio file;
means for extracting the embedded audio file;
means for storing the extracted audio file; and
means for associating the extracted audio file with the image file.

14. The system of claim 13, further comprising means for attaching the extracted audio file and the image file to an email message.

15. The system of claim 14, further comprising means for representing the extracted audio file and the image file using separate icons.

16. The system of claim 13, further comprising means for compressing the image file.

17. The system of claim 13, further comprising means for extracting the embedded audio file by analyzing the image file for a marker representing the embedded audio file.

18. The system of claim 13, further comprising means for separately executing the extracted audio file and the image file.
